(19) United States
(12) Patent Application Publication
(10) Pub. No.: US 2007/0183147 A1
(43) Pub. Date: Aug. 9, 2007

(54) Non-tangling Christmas light assembly

(76) Inventor: Marc S. Herlands, Encinitas, CA (US)

Correspondence Address: Wesley B. Ames;Ames IP Law, 7031 Los Vientos Serenos, Escondido, CA, 92029, US

(21) Appl. No.: 11/346,886

(22) Filed: Feb. 3, 2006

(51) Int. Cl. F21S 4/00

(52) U.S. Cl. 362/217; 362/225

(57) ABSTRACT

Spring coiled holiday light strings are described that can be expanded for stringing on a Christmas tree or other surface and conveniently re-coiled for storage and later reuse.

### RELATED APPLICATIONS

NOT APPLICABLE.

### FIELD OF THE INVENTION

The present invention relates to light strings for Christmas lights and other holiday light strings, as well as other applications for light strings.

### BACKGROUND OF THE INVENTION

The following discussion is provided solely to assist the understanding of the reader, and does not constitute an admission that any of the information discussed or references cited constitute prior art to the present invention.

Strings of lights are commonly used for holiday decororation, for example, for decorating Christmas trees, buildings, and the like. Typically, such light strings are constructed of straight, plastic coated conductors, with the light fittings connected in either parallel or series fashion. At one end of the light string is a power connector, usually a power plug adapted to connect to a conventional wall receptable. Commonly, the other end of the string has a receptable for linking an additional light string for extending the light display.

When initially purchased, the lights are typically packaged in a cardboard or plastic carrier that hold the light string in a particular pattern and prevents the lights and conductors from becoming entangled. However, once the lights are removed, the conductors are typically substantially straightened, so that replacement of the lights in the carrier becomes difficult and very time-consuming. As a result, usually the light string is simply placed in a bag, box, or similar container, which frequently results in entanglements which complicate reuse of the light string and/or increase breakage of the conductors, connections between the conductors and light fittings and/or lights, or disturbance of connections between lights and the corresponding fittings.

### SUMMARY OF THE INVENTION

The present invention concerns light strings (especially holiday light strings such as Christmas lights) that can be conveniently installed and subsequently stored for re-use while avoiding tangling and breakage. This is accomplished by utilizing self-coiling (recoilable) light strings. Such light strings can be constructed in various ways, but incorporate a spring that has sufficient spring tension to at least significantly assist in restoring the string to a retracted, fully coiled state, but not so much that it is difficult to extend the light string. For example, the tension for Christmas lights should not be so great that installation of the lights on a tree causes significant bending of the major branches.

Thus, in a first aspect, the invention concerns a recoilable light string that has a flat coil spring, a plurality of sequentially-linked lights distributed along the spring coil, and a power plug at one end of the spring coil linked with the lights.

In certain embodiments, the light string extends to 2-6 feet, 6-10 feet, 8-12 feet, 10-20 feet, 15-30 feet; the light string coil is 6-12, 9-15, or 12-18 inches when fully retracted; the spring coil is a pitchless coil; the coil has a diameter of 1-4, 2-4, 2-6, 3-6, 4-8, or 6-12 inches when fully retracted; the flat coil spring has a spring portion of spring steel; the spring portion is spring steel in the form of a flat coiled strip; the spring portion is spring steel in the form of a coiled rod; a spring steel spring coil is coated with a plastic; conductors are embedded in a plastic coating over a metal spring coil; the spring coil portion is a plastic; the spring coil portion is plastic in the form of a flat coiled strip; the spring coil portion is plastic in the form of a flat coiled rod; conductors are adhered to the surface of a plastic flat coiled strip; the spring coil portion is plastic in the form of a coiled tube; electrical conductors for the lights are located in the interior of the tube; electrical conductors for the lights are located in the side walls of the tube; electrical conductors for the lights are located on the exterior of the tube.

In particular embodiments, the lights are located in the interior of the tube; the lights naturally fall on the outside of the coil; the lights naturally fall on the inside of the coil; the lights naturally alternate between falling on the inside and outside of the coil; the lights are light emitting diodes (LEDs); the lights are incandescent lights; the lights are neon lights; the lights are optical fiber termini; the light string has a clip on at least one end, on one end, or on each end; the light string has a power receptacle connected at the end of the spring coil suitable for sequential linking of a second spring coil.

In a related aspect, the invention concerns a packaged light string, that includes a recoilable light string packaged in a tubular container and/or on a core fitting the interior of the coil, where the container is sized such that the internal diameter of the container is sized to accommodate the recoilable light string when in compact configuration while maintaining stacking of the spring coils, and the light string is contained within the tubular container. The core can be cylindrical, with projections describing a circle, or other shape that at least loosely fits the interior of the light string coil. The light string inclucludes a flat spring coil (e.g., having a coil diameter of 2-6, 4-8, or 6-12 inches, or other diameter as described herein), a plurality of sequentially-linked lights distributed along the spring coil; and a power cord linked with the lights.

In particular embodiments, the light string is as described above or otherwise described herein; the tube is a circular cylinder, a triangular cross-section tubular container, a square cross-section tubular container.

In particular embodiments, the packaged light string also includes written and/or pictorial instructions for storing the light string in the tubular container.

In another related aspect, the invention concerns a method for decorating a Christmas tree or other structure or surface with lights by expanding a recoilable light string as described herein, and placing the light string on the tree (or other structure or surface). Certain embodiments include replacing the light string in the tubular container, e.g., by releasing the light string from the tree or other mounting surface, allowing the string to retract and/or assisting the string to retract, and placing the light string in the container such that it rests in the container in retracted configuration.

Additional embodiments will be apparent from the Detailed Description and from the claims.

### DESCRIPTION OF THE DRAWINGS

FIG. 1 shows a section of an extended spring coil light string with a generally rod- or cylindrically-shaped spring coil.

FIG. 2 shows the spring coil light string of FIG. 1 in fully retracted form where the lights are located on the interior of the coil, along with a cylinder for storage.

FIG. 3 shows a section of an extended spring coil light string in which the lights are in the interior of a tube-shaped spring coil.

FIG. 4 shows a section of a partially extended spring coil light string with a generally flat strip spring coil.

### DETAILED DESCRIPTION OF THE PREFERRED EMBODIMENTS

The present invention addresses the difficulties associated with reuse of Christmas lights and other light strings such as those for other holiday use. Many current light strings for decorating Christmas trees and the like are constructed of conventional insulated light gauge wire with light fixtures mounted periodically along the conductors. Such light strings can be constructed either using series wiring or parallel wiring. In addition to holiday use, the present light strings can be used for demarcation or walkway illumination by placement along pathways or railings.

When initially purchased, such light strings are typically mounted on a cardboard or plastic alignment carrier or frame. The light string is progressively removed from such carrier or frame, the wires at least partially straightened, and the light string installed in the desired location.

Once straightened, the light string becomes very difficult and time-consuming to replace on the carrier. As a result, such light strings are commonly loosely place in a bag or box for storage. Unfortunately, such loose storage frequently results in tangling and/or breakage of lights, light fittings, and/or connections to the light fittings.

The present invention responds to this difficulty by providing light strings that can be readily stored in a manner that resists tangling and breakage, thereby making the light strings more amenable to repetitive reuse.

This is accomplished by using coil spring light strings. In such light strings, the spring coil has a relatively light spring tension so that it can be extended and placed on a tree, railing, house eave, or other surface without requiring excessive force. To assist in holding the coil in position, clips can be place on the string, e.g., at an end, at both ends, or at the end(s) and at least one middle position.

The present light strings can be provided to utilize any desired type of electrical power. In particular, the lights can be adapted to operate with conventional U.S line electricity (i.e., 60 Hz, 110-125 V) or European standard line power (i.e., 50 Hz, 220-240 V), or other national electricity standards.

As used herein, the term “flat coil” refers to a coil in which the pitch is low, e.g., less than 0.5 d, where d is the coil diameter, and usually less than 0.4 d, 0.3 d, 0.25 d, or 0.2 d. A “pitchless coil” is a flat coil in which the subsequent turns of the coil essentially contact each other when the coil is fully retracted. A familiar example of a pitchless spring coil is a SLINKY® toy.

In the context of this invention, the term “plastic” is intended to mean a formable polymeric substance including thermoplastic resins which after melting solidify upon cooling and thermosetting resins which solidify upon being heated to a sufficient cross-linking temperature. Exemplary plastics used in making springs include nylon, polyacetal, polypropylene, and polycarbonate.

In connection with the extension and retraction of coil springs, the term “fully retracted” means that that spring is at a point that there are neither retractive not expansive forces, i.e., such that there is no stored mechanical potential energy in the spring.

The term “recoilable light string” refers to a light string that includes a coil spring, with the lights distributed along the coil. The coil can be expanded (so long as the expansion does not exceed the spring range) and returned to a retracted state, at least partially under the restoring force of the spring.

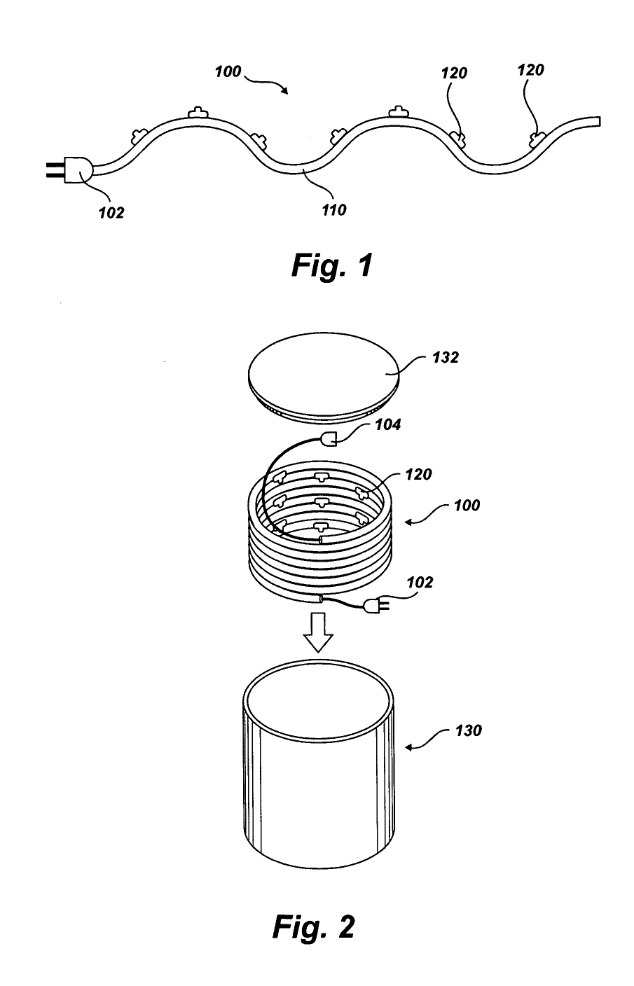

An exemplary coil spring light string is illustrated in FIG. 1 and FIG. 2. In FIG. 1, a section of the coil is shown extended suitable for placement on a Christmas tree, house eave, railing, pathway, or the like. The extended light string retains an open or extended coil pattern (unless extended under high tension to completely straighten the coil). As illustrated, the light string 100 includes a power plug 102 electrically connected to conductors (not shown) that extend along spring coil 110, with light fittings 120 distributed along the length.

FIG. 2 illustrates the light string of FIG. 1 in a fully retracted configuration, along with a cylindrical container 130 in which the retracted light string 100 is stored. In coiled position, the lights 120 are oriented generally toward the center of the cylindrical coil. The cylindrical container is slightly larger than the diameter of the light string coil to allow convenient removal and replacement. The container includes a removable and replaceable cap 132. Such tubular container can be constructed of any of a variety of materials and combinations of such materials, for example, plastic (e.g., clear, translucent, or opaque), cardboard or other stiff paper material, or metal.

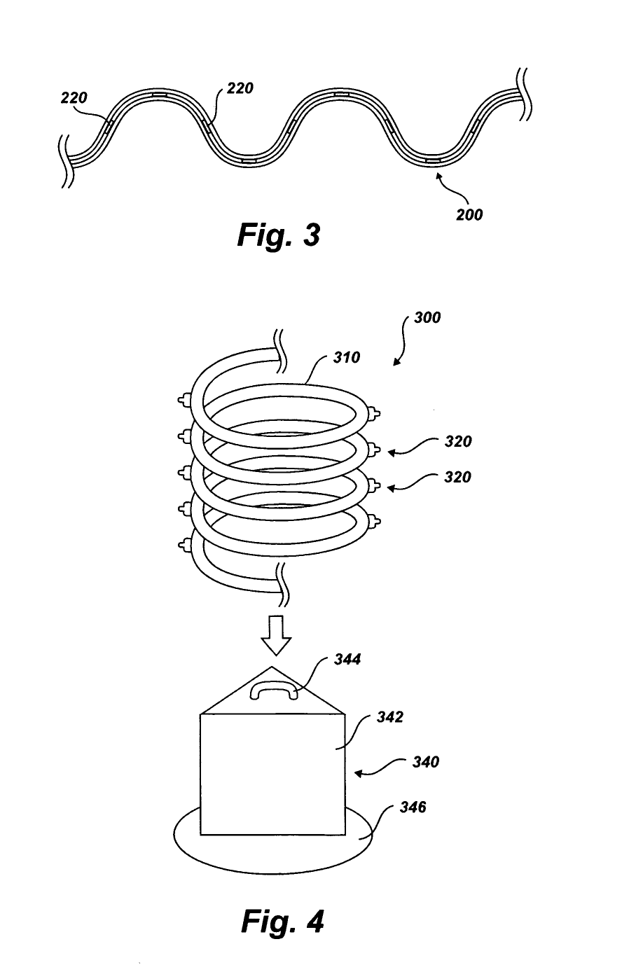

FIG. 3 shows a section of a light string 200 in which the lights 220 are internal in a tubular coil flat spring coil.

FIG. 4 shows a section of a partially extended light string 300 in which the coil spring is in the form of a coiled flat strip 310. In this embodiment, the lights 320 are oriented on the outside of the spring coil. Such design with outside oriented lights is well adapted for use with a storage core that fits the inside of the coil. Illustrated is a triangular core 340 that has triangular support core 342, with a lift handle 344 at the top, and support base 346 at the bottom which prevents the retracted light string from slipping off the bottom of the core support.

All patents and other references cited in the specification are indicative of the level of skill of those skilled in the art to which the invention pertains, and are incorporated by reference in their entireties, including any tables and figures, to the same extent as if each reference had been incorporated by reference in its entirety individually.

One skilled in the art would readily appreciate that the present invention is well adapted to obtain the ends and advantages mentioned, as well as those inherent therein. The methods, variances, and compositions described herein as presently representative of preferred embodiments are exemplary and are not intended as limitations on the scope of the invention. Changes therein and other uses will occur to those skilled in the art, which are encompassed within the spirit of the invention, are defined by the scope of the claims.

It will be readily apparent to one skilled in the art that varying substitutions and modifications may be made to the invention disclosed herein without departing from the scope and spirit of the invention. For example, variations can be made to the material, size, and shape of the coil spring. Thus, such additional embodiments are within the scope of the present invention and the following claims.

The invention illustratively described herein suitably may be practiced in the absence of any element or elements, limitation or limitations which is not specifically disclosed herein. Thus, for example, in each instance herein any of the terms “comprising”, “consisting essentially of” and “consisting of” may be replaced with either of the other two terms. The terms and expressions which have been employed are used as terms of description and not of limitation, and there is no intention that in the use of such terms and expressions of excluding any equivalents of the features shown and described or portions thereof, but it is recognized that various modifications are possible within the scope of the invention claimed. Thus, it should be understood that although the present invention has been specifically disclosed by preferred embodiments and optional features, modification and variation of the concepts herein disclosed may be resorted to by those skilled in the art, and that such modifications and variations are considered to be within the scope of this invention as defined by the appended claims.

In addition, where features or aspects of the invention are described in terms of Markush groups or other grouping of alternatives, those skilled in the art will recognize that the invention is also thereby described in terms of any individual member or subgroup of members of the Markush group or other group.

Also, unless indicated to the contrary, where various numerical values or value range endpoints are provided for embodiments, additional embodiments are described by taking any 2 different values as the endpoints of a range or by taking two different range endpoints from specified ranges as the endpoints of an additional range. Such ranges are also within the scope of the described invention.

Thus, additional embodiments are within the scope of the invention and within the following claims.

What is claimed is:

1. A recoilable light string, comprising
a flat spring coil, wherin said coil has a diameter of 2 to 12 inches when fully retracted;
a plurality of sequentially-linked lights distributed along said spring coil; and
a power plug at one end of said spring coil linked with said lights.

2. The light string of claim 1, wherein said flat spring coil comprises spring steel.

3. The light string of claim 2, wherein said spring steel is in the form of a flat coiled strip.

4. The light string of claim 1, wherein said flat spring coil comprises a plastic.

5. The light string of claim 4, wherein said plastic is in the form of a flat coiled strip.

6. The light string of claim 4, wherein said plastic is in the form of a coiled tube.

7. The light string of claim 6, wherin electrical conductors for said lights are located in the interior of said tube.

8. The light string of claim 6, wherein electrical conductors for said lights are located in the side walls of said tube.

9. The light string of claim 6, wherein electrical conductors for said lights are located on the exterior of said tube.

10. The light string of claim 6, wherein said lights are located in the interior of said tube.

11. The light string of claim 1, wherein said lights naturally fall on the outside of said coil.

12. The light string of claim 1, wherein said lights naturally fall on the inside of said coil.

13. The light string of claim 1, wherein said lights naturally alternate between falling on the inside and outside of said coil.

14. The light string of claim 1, wherein said lights are LEDs.

15. The light string of claim 1, wherein said lights are incandescent lights.

16. The light string of claim 1, wherein said lights are halogen lights.

17. The light string of claim 1, wherein said lights are neon lights.

18. The light string of claim 1, wherein said lights are optical fiber termini.

19. The light string of claim 1, further comprising a clip on at least one end.

20. The light string of claim 1, further comprising a clip on each end.

21. The light string of claim 1, further comprising a power receptacle connected at the end of said spring coil distal from said power plug suitable for sequential linking of a second spring coil.

22. A packaged light string, comprising
a recoilable light string, comprising
a flat spring coil, wherin said coil has a diameter of 2 to 12 inches;
a plurality of sequentially-linked lights distributed along said spring coil; and
a power cord linked with said lights.
a tubular container, wherein said container is sized such that the internal diameter of said container is sized to accommodate said recoilable light string when in compact configuration while maintaining stacking of the spring coils,
wherein said recoilable light string is contained within said tubular container.

23. The packaged light string of claim 22, further comprising written instructions for storing said light string in said tubular container.

24. A method for decorating a Christmas tree with lights, comprising
expanding a recoilable light string and placing said light string on said tree,
wherein said light string comprises
a flat spring coil, wherin said coil has a diameter of 2 to 12 inches;
a plurality of sequentially-linked lights distributed along said spring coil; and
a power cord linked with said lights.
